(19) United States
(12) Patent Application Publication
(10) Pub. No.: US 2025/0231348 A1
(43) Pub. Date: Jul. 17, 2025

(54) LIGHT GUIDE MODULE

(71) Applicant: LG INNOTEK CO., LTD., Seoul (KR)

(72) Inventors: Kyu Tae LEE, Seoul (KR); Bum Jin KIM, Seoul (KR)

(21) Appl. No.: 18/852,943

(22) PCT Filed: Sep. 26, 2023
(86) PCT No.: PCT/KR2023/014932

§ 371 Date: Sep. 30, 2024

(30) Foreign Application Priority Data
Sep. 30, 2022 (KR) 10-2022-0125014

(51) Int. Cl. G02B 6/34; G02B 27/01

(52) U.S. Cl. CPC G02B 6/34; G02B 27/0101; G02B 2027/0192

(57) ABSTRACT

A light guide module according to an embodiment comprises a first light guide and a second light guide, wherein the first light guide includes a first pattern region that reacts with first light having a first wavelength and third light having a third wavelength, the second light guide includes a second pattern region that reacts with second light having a second wavelength and the third light having the third wavelength, the first pattern region includes multiple first patterns, the second pattern region includes multiple second patterns different from the first patterns, and each of the first patterns is thickest in a central region including the center thereof and is symmetrical with respect to a first direction passing through the center.

### TECHNICAL FIELD

The embodiment relates to a light guide module.

### BACKGROUND ART

Recently, with the advancement in technology, various types of wearable devices that can be worn on a body are released. Among them, augmented reality (AR) devices are wearable devices in the form of glasses worn on a user's head. The AR devices provide visual information through a display. According thereto, users may receive AR services.

Augmented reality is a mixture of real-world information and virtual images by inserting three-dimensional images into a real environment.

The real-world information may include information that users do not need. Or, the real-world information may lack information that users need. However, augmented reality systems combine a real world and a virtual world. According thereto, interactions between the real world and the virtual world are accomplished in real time.

Unlike virtual reality (VR) devices that block vision, augmented reality (AR) devices do not block vision while being used. In addition, the augmented reality (AR) devices show a wide screen-level display in front of a user while being worn on like regular glasses. In addition, the augmented reality (AR) devices may provide an extended reality that combines the reality and AR contents by utilizing a 360° space from the viewpoint of a user. In addition, the augmented reality (AR) devices may provide a display optimized for the user while both hands are free.

The augmented reality device includes an optical module. The optical module provides augmented reality images to the user. For example, the augmented reality device may be configured as wearable glasses, which are an optical device. In addition, a projector that projects images on the wearable glasses may be combined.

Light emitted from the projector passes through the optical device and enters user's eyes. According thereto, the user perceives an augmented reality display.

The light emitted from the projector enters user's eyes after being diffracted by the optical device. Accordingly, the optical device may include a diffraction pattern. The diffraction pattern generates a difference in the efficiency of diffraction according to the wavelength size. Accordingly, in order to satisfy the diffraction efficiencies of red light, green light, and blue light, three sheets of light guide each including a diffraction pattern suitable for each wavelength are required. Accordingly, there is a problem in that thickness of the display device increases.

Therefore, a light guide having improved diffraction efficiency and small thickness is required.

### DISCLOSURE

### Technical Problem

The embodiment provides a light guide module having improved diffraction efficiency and reduced thickness.

### Technical Solution

A light guide module according to an embodiment includes a first light guide and a second light guide, wherein the first light guide includes a first pattern region that reacts with first light of a first wavelength and third light of a third wavelength, the second light guide includes a second pattern region that reacts with second light of a second wavelength and the third light of the third wavelength, the first pattern region includes a plurality of first patterns, the second pattern region includes a plurality of second patterns different from the first patterns, and the first pattern is widest in a central region including a center and is symmetrical with respect to a first direction passing through the center.

### Advantageous Effects

A light guide module according to an embodiment includes two light guides. Specifically, the light guide module includes a first light guide and a second light guide.

The light guide module includes two light guides that diffract blue light, red light, and green light. Specifically, the light guide module includes a first light guide that diffracts blue light and green light, and a second light guide that diffracts red light and green light.

According thereto, the number of light guides is decreased. Accordingly, the size of the light guide module and a display device including the same is reduced.

In addition, each of the plurality of light guides includes a pattern that reacts with light of a wavelength band of a range set in advance.

In each of the plurality of light guides, the shape of the pattern is controlled. In addition, in each of the plurality of light guides, the thickness of the pattern is controlled. In addition, in each of the plurality of light guides, the size of a unit pattern is controlled. In addition, in each of the plurality of light guides, the symmetry direction of the unit pattern is controlled. In addition, in each of the plurality of light guides, the shape of the unit pattern is controlled.

Accordingly, blue light, red light, and green light are diffracted while having optimal diffraction efficiency. Therefore, the light guide module has uniform and high diffraction efficiency within a wide range of incident angle.

### DESCRIPTION OF DRAWINGS

FIG. 1 is a view for explaining the flow of light passing through a light guide module according to an embodiment.

FIG. 2 is a view showing a first light guide and a second light guide according to an embodiment.

FIG. 3 is a view for explaining a light guide according to an embodiment.

FIG. 4 is a view for explaining arrangement of a light guide module according to an embodiment.

FIGS. 5 to 7 are top views showing a first light guide according to an embodiment.

FIGS. 8 to 10 are graphs for explaining diffraction efficiency of a first light guide according to the embodiment.

FIGS. 11 to 13 are top views showing a second light guide according to an embodiment.

FIGS. 14 to 16 are graphs for explaining diffraction efficiency of a first light guide according to the embodiment.

FIG. 17 is a view showing a wearable device to which a light guide member according to an embodiment is applied.

### MODE FOR INVENTION

Hereinafter, preferred embodiments of the present invention will be described in detail with reference to accompanying drawings.

However, the technical spirit of the present invention is not limited to some of the described embodiments, but may be implemented in various different forms, and one or more of the components may be selectively combined or replaced among the embodiments without departing from the scope of the technical spirit of the present invention. In addition, unless explicitly and specifically defined and described, terms (including technical and scientific terms) used in the embodiments of the present invention may be interpreted as a meaning that can be generally understood by those skilled in the art, and commonly used terms, such as terms defined in a dictionary, may be interpreted considering the contextual meaning of related techniques.

In addition, the terms used in the embodiments of the present invention are for describing the embodiments and are not intended to limit the present invention. In this specification, singular forms may also include plural forms unless specifically stated in the phrase, and when it is described as “at least one (or more) among A, B, and C,” it may include one or more of all combinations that can be combined using A, B, and C.

In addition, in describing the components of the embodiments of the present invention, terms such as first, second, A, B, (a), and (b) may be used. These terms are used only to distinguish one component from other components, and the nature, sequence, or order of the components are not limited by the terms. In addition, when a component is described as being ‘connected’, ‘coupled’, or ‘combined’ to another component, it may also include the cases where the component is ‘connected’, ‘coupled’, or ‘combined’ by still another component arranged between the component and another component, as well as the cases where the component is directly coupled, connected, or combined to another component.

In addition, when it is described as being formed or arranged “on (above)” or “under (below)” each component, it may also include the cases where one or more other components are formed or arranged between two components, as well as the cases where two components are directly in contact with each other. In addition, when it is expressed as “on (above) or under (below)”, it may also include the downward direction, as well as the upward direction, from the aspect of one component.

A first direction and a second direction described below may be the X-axis direction (left-right direction) or the Y-axis direction (up-down direction), respectively. For example, the first direction is the X-axis direction, and the second direction is the Y-axis direction. Alternatively, the first direction is the Y-axis direction, and the second direction is the X-axis direction.

Hereinafter, a light guide module according to an embodiment will be described with reference to the drawings. The light guide module may include a waveguide.

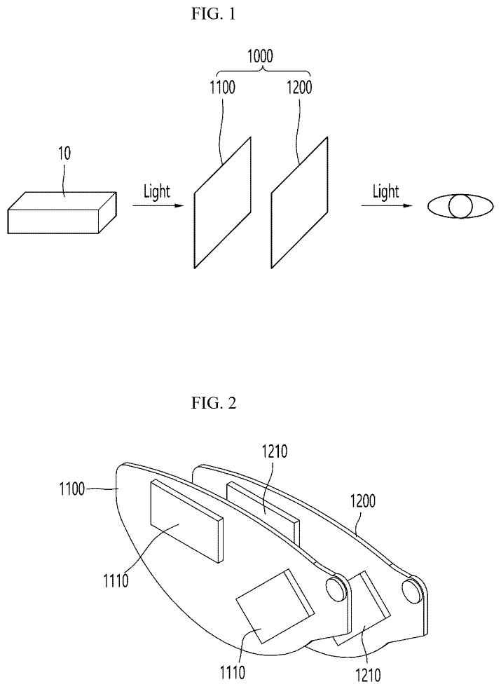

Referring to FIG. 1, light is emitted from a light source 10. Specifically, a laser beam is emitted from the light source 10. The light passes through the light guide module 1000 and enters user's eyes. For example, the light source 10 may include a projector.

FIG. 1 shows that the light source 10 and the user's eyes are arranged on both sides of the light guide module 1000. However, the embodiment is not limited thereto, and the light source 10 and the user's eyes may be arranged on the same side of the light guide module 1000.

The light source 10 emits a plurality of lights each having a different color. Specifically, the light source 10 emits a plurality of lights each having a different wavelength. For example, the light source 10 may emit a first light, a second light, and a third light. Specifically, the first light is blue light. The second light is red light. The third light is green light. The first light has a first wavelength. The second light has a second wavelength. The third light has a third wavelength.

The light guide module 1000 includes a plurality of light guides. Specifically, the light guide module 1000 includes a first light guide 1100 and a second light guide 1200.

Referring to FIG. 2, the first light guide 1100 includes a first pattern region 1110. The first pattern region 1110 reacts with the first wavelength and the third wavelength. Accordingly, the first pattern region 1110 guides blue light. In addition, the first pattern region 1110 guides a part of green light. Specifically, a part of the green light and the blue light are diffused by the first pattern region 1110. In addition, another part of the green light and the red light pass through the first pattern region 1110. The first pattern region 1110 includes a first pattern. The first pattern includes a plurality of first unit patterns.

The second light guide 1200 includes a second pattern region 1210. The second pattern region 1210 reacts with the second wavelength and the third wavelength. Accordingly, the second pattern region 1120 guides red light. In addition, the second pattern region 1210 guides another part of the green light. That is, the second pattern region 1210 guides green light that is not guided in the first pattern region 1110. Specifically, another part of the green light and the red light are diffused by the second pattern region 1210. A part of the green light and the blue light pass through the second pattern region 1210. The second pattern region 1210 includes a second pattern. The second pattern includes a plurality of second unit patterns.

The first pattern region 1110 and the second pattern region 1210 overlap each other. Specifically, the first pattern region 1110 and the second pattern region 1210 overlap in a direction perpendicular to one side of the first light guide.

The first pattern and the second pattern include a diffraction pattern. That is, the first pattern is a first diffraction pattern. In addition, the second pattern is a second diffraction pattern.

The first pattern and the second pattern react only in a wavelength region of a range set in advance. That is, the first pattern and the second pattern have wavelength selective characteristics. Accordingly, the first light, the second light, and the third light are diffracted in at least one light guide among the first light guide 1100 and the second light guide 1200.

The first light and the second light are diffracted in light guides different from each other. In addition, the third light is diffracted in at least one light guide among of the first light guide and the second light guide.

Accordingly, three lights are diffracted through two light guides. Therefore, thickness of the light guide module is reduced compared to the case of using three light guides. In addition, thickness of a display device to which the light guide module is applied is reduced.

In order to improve visibility of the user, light having a wide incident angle should be diffracted. In addition, the diffraction efficiency should be uniform and high within the range of incident angle.

Hereinafter, the diffraction pattern of a light guide having uniform and high diffraction efficiency within the range of incident angle, while having a bandwidth of a wide incident angle, will be described.

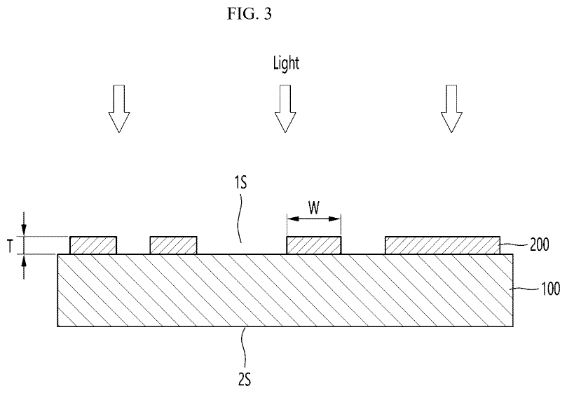

Referring to FIG. 3, at least one light guide among the first light guide and the second light guide includes a substrate 100 and a structure body 200.

The substrate 100 includes a material that can transmit light. For example, the substrate 100 may include glass or plastic. For example, the substrate 100 may include polyethylene terephthalate (PET) or polyimide (PI).

The substrate 100 supports the structure body 200. The substrate 100 includes a first surface 1S and a second surface 2S opposite to the first surface 1S. Light entering the light guide is input into the first surface 1S and emitted from the first surface 1S. For example, light entering the light guide passes through an in-coupling structure body of the first surface 1S and enters inside the substrate 100. Then, the light is totally reflected inside the substrate 100. Subsequentially, the light passes through an out-coupling structure body of the first surface 1S and is emitted to the outside of the first surface 1S.

The structure body 200 may be at least one among an in-coupling structure body and an out-coupling structure body. For example, the structure body 200 may be an in-coupling structure body. Alternatively, the structure body 200 may be an out-coupling structure body. Alternatively, the structure body 200 may be an in-coupling structure body and an out-coupling structure body.

The structure body 200 is arranged on the substrate 100. The structure body 200 is arranged on the first surface 1S. The structure body 200 may be the first pattern and the second pattern.

The structure body 200 may include a material the same as or similar to that of the substrate 100. Alternatively, the structure body 200 may include a material different from that of the substrate 100. For example, the structure body 200 may include TiOx, HfOx, SiOx, Si, GaAs, or Ge.

The structure body 200 may be a diffraction pattern. That is, the light passing through the light guide is diffracted by the structure body 200. The structure body 200 may include a plurality of patterns. The plurality of patterns may be spaced apart from each other. The structure body 200 may be formed as a meta surface of a freeform shape. Accordingly, light having a wavelength of a range set in advance is diffracted at a diffraction angle of a range set by the light guide.

The structure body 200 may have a width W and a thickness T within a range set in advance. For example, the structure body 200 may have a thickness within a range set in advance. For example, the structure body 200 may be formed at a similar thickness throughout the entire area of the substrate 100. In addition, the structure body 200 may have a width within a range set in advance. For example, the structure body 200 may be formed at different widths throughout the entire area of the substrate 100. That is, the width of a structure body arranged in one area of the substrate 100 and the width of a structure body arranged in another area may be different. Accordingly, the structure body 200 may have a similar thickness throughout the entire area of the substrate 100 while having a width of a different size.

In addition, the substrate 100 and the structure body 200 may have a refractive index of a range set in advance.

For example, the substrate 100 and the structure body 200 may have a refractive index of 1.5 to 4. The substrate 100 and the structure body 200 may have the same refractive index or different refractive indexes within the range. For example, the refractive index of the structure body 200 may be higher than the refractive index of the substrate 100.

Diffraction efficiency of the light guide module is determined by the intensity of light traveling in the direction of diffraction angle with respect to the intensity of incident light. In addition, the intensity of the light passing through the light guide module is determined by the transmittance and phase change after transmission, which are results of the interaction between the incident light and the structure body.

That is, intensity of light traveling in the direction of diffraction angle varies by the shape, arrangement, and size of the pattern of the light guide.

The light guide module arranges patterns in a shape having optimal diffraction efficiency according to the wavelength of light entering the first light guide and the second light guide. Accordingly, the light passing through each light guide has uniform and high diffraction efficiency within a wide range of incident angle.

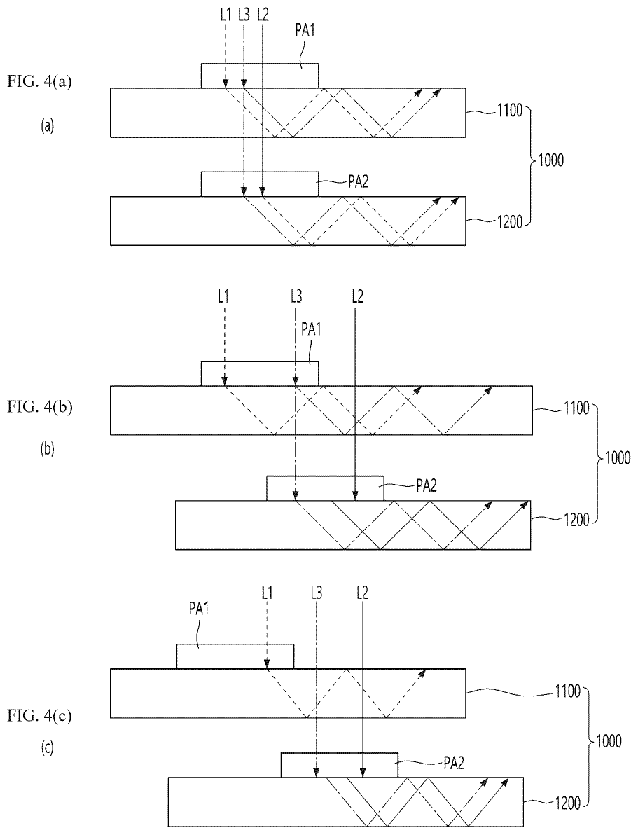

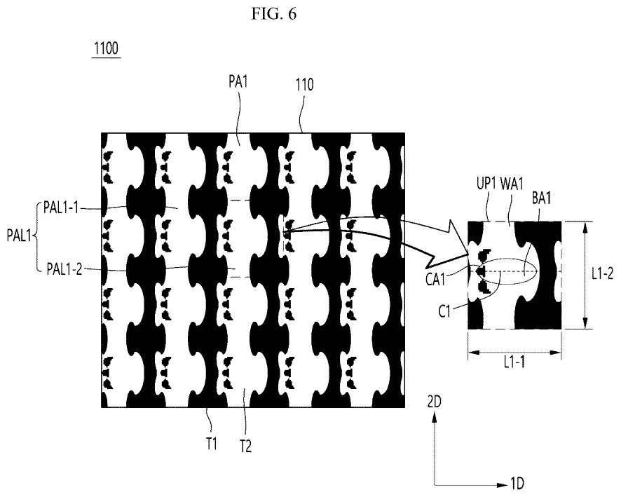

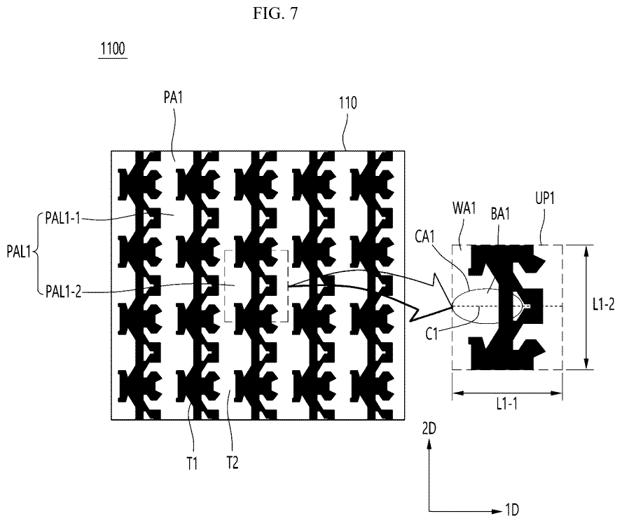

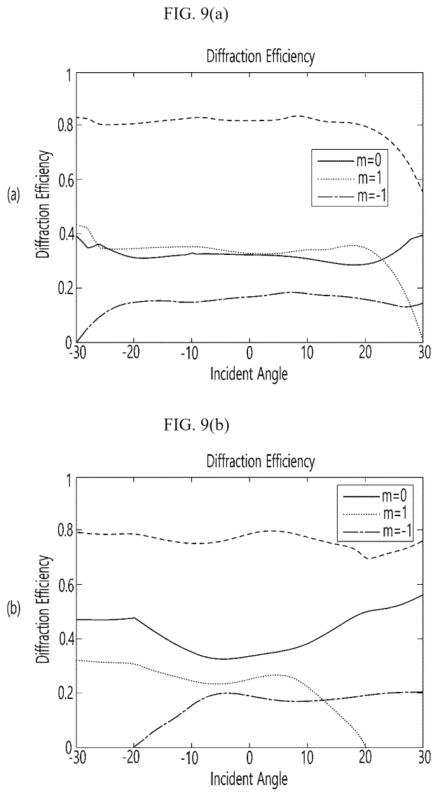

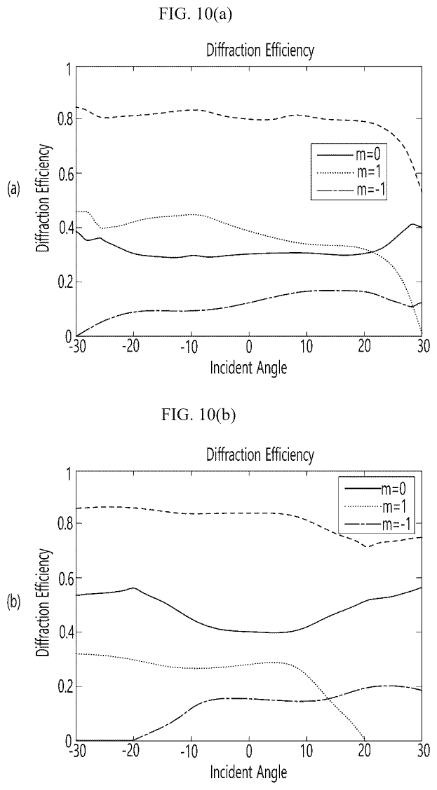

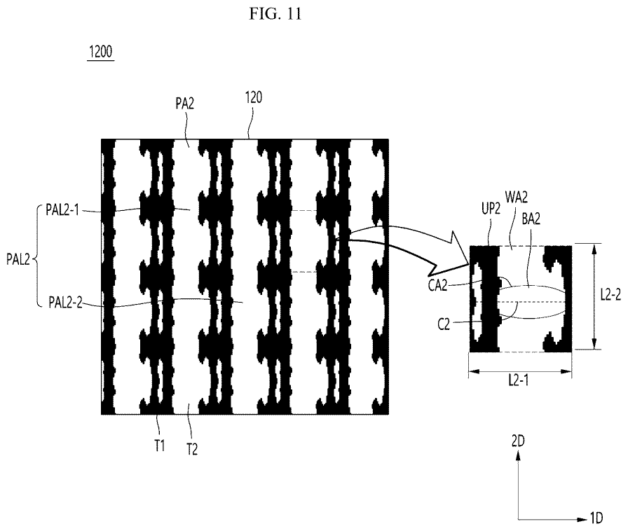

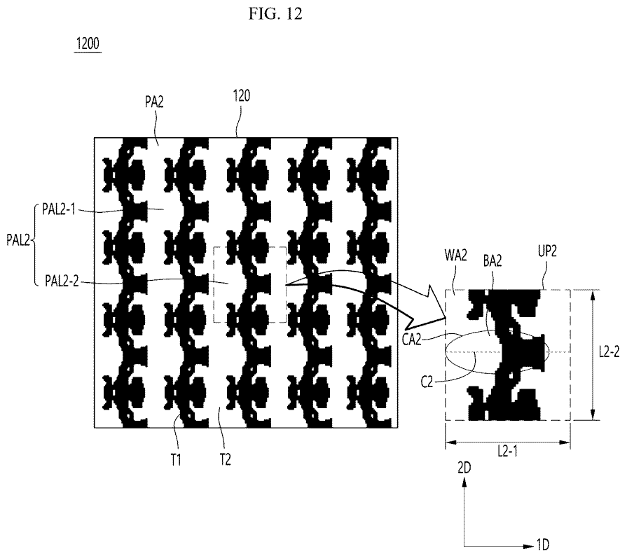

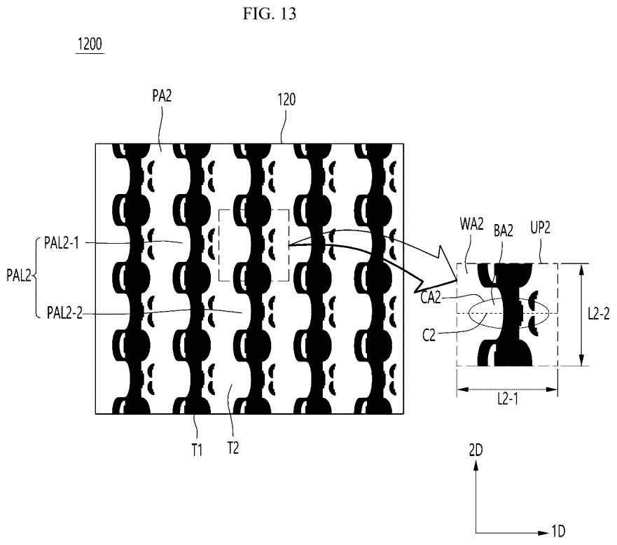

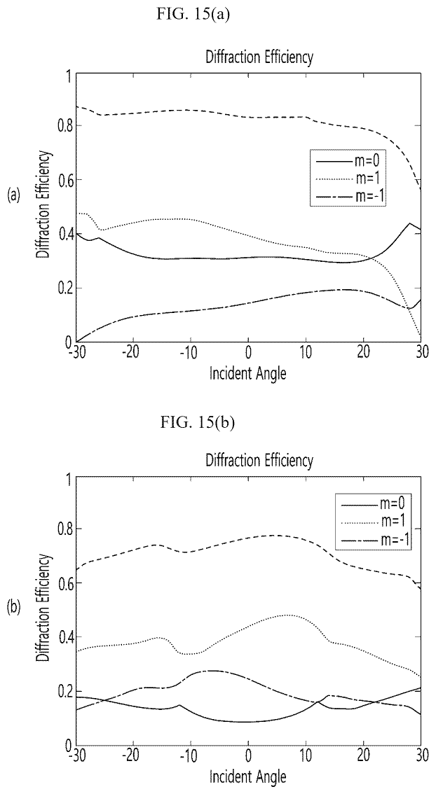

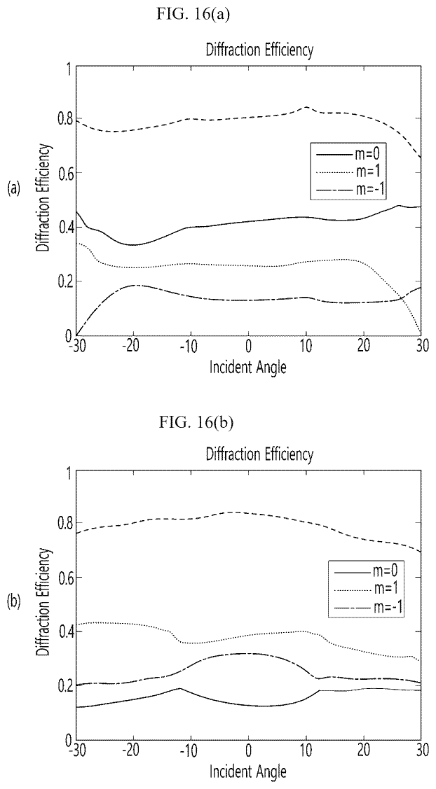

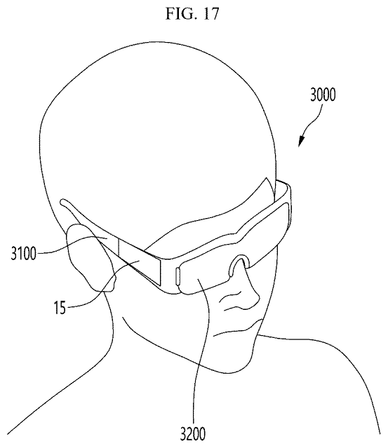

Hereinafter, the first light guide and the second light guide will be described with reference to FIGS. 4 to 16.

Referring to FIG. 4, the light guide module 1000 includes a first light guide 1100 and a second light guide 1200.

The first light guide 1100 is arranged on the second light guide 1200. Specifically, the first light guide 1100 and the second light guide 1200 are arranged sequentially along the moving path of light. The first light guide 1100 includes a first pattern PA1. The second light guide 1200 includes a second pattern PA2.

The first pattern PA1 selectively reacts with a wavelength of a range set in advance. Accordingly, the first light L1 is totally reflected inside the first light guide 1100.

The second pattern PA2 selectively reacts with a wavelength of a range set in advance. Accordingly, the second light L2 is totally reflected inside the second light guide 1200.

In addition, the third light L3 is totally reflected inside at least one among the first light guide 1100 and the second light guide 1200. For example, as shown in (a) and (b) of FIG. 4, the third light L3 is totally reflected inside the first light guide 1100 and the second light guide 1200. Or, as shown in (c) of FIG. 4, the third light L3 is totally reflected inside the second light guide 1200.

That is, the first pattern PA1 reacts with the first light L1 and the third light L3. In addition, the second pattern PA2 reacts with the second light L2 and the third light L3.

In order to improve the diffraction efficiency of the light, the first pattern PA1 and the second pattern PA2 may have a shape and size set in advance. In addition, the first pattern PA1 and the second pattern PA2 may be arranged at a position set in advance.

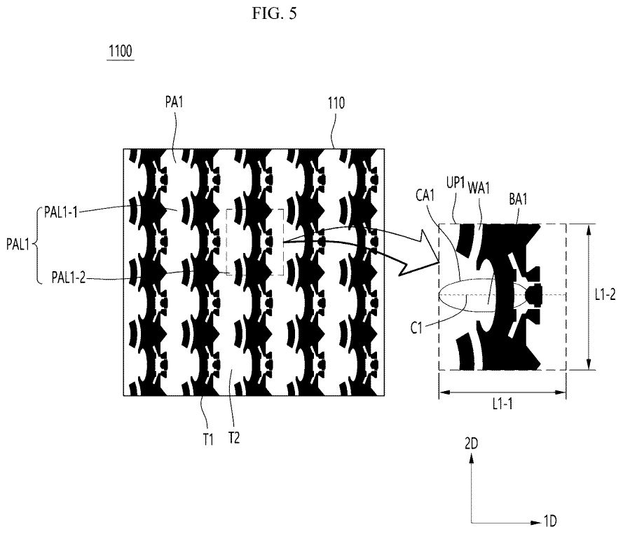

Referring to FIGS. 5 to 7, the first light guide 1100 includes a first substrate 110 and a first pattern PA1.

The first pattern PA1 diffracts light having a wavelength of a range set in advance. Specifically, the first pattern PA1 selectively diffracts at least one light among the first light and the third light. Specifically, the first pattern PA1 selectively diffracts blue light. Alternatively, the first pattern PA1 selectively diffracts green light. Alternatively, the first pattern PA1 selectively diffracts blue light and green light.

Hereinafter, for convenience of explanation, a case where the first pattern PA1 selectively diffracts the first light and the third light is described.

The first substrate 110 includes a first transmission region T1 and a second transmission region T2 by the first pattern PA1. The first transmission region T1 is a region where the first pattern PA1 is not arranged. The second transmission region T2 is a region where the first pattern PA1 is arranged. Light passing through the first light guide 1100 is diffracted by the first transmission region T1 and the second transmission region T2. Specifically, a phase difference occurs between the light passing through the first transmission region T1 and the light passing through the second transmission region T2. The sum of the phase difference may appear as a diffraction phenomenon.

The first pattern PA1 may include a plurality of unit patterns. For example, the first pattern PA1 may include a plurality of first unit patterns UP1. When the first substrate 110 is divided into a plurality of unit areas, a structure in which a structure body of the same shape is repeated in the plurality of unit areas is defined as the first unit pattern UP1.

The first unit pattern UP1 is arranged on the surface of the first light guide where light enters. In addition, the light entering the first light guide is guided by the first unit pattern UP1.

The first unit patterns UP1 are connected to each other. Accordingly, a first pattern line PAL1 is formed.

The first pattern PA1 includes a plurality of first pattern lines PAL1. In addition, the first pattern lines PAL1 are spaced apart from each other. Specifically, the first pattern lines PAL1 are not connected to each other.

For example, the first pattern PA1 may include a 1-1 pattern line PAL1-1 and a 1-2 pattern line PAL1-2. The 1-1 pattern line PAL1-1 and the 1-2 pattern line PAL1-2 extend in the second direction 2D. That is, the 1-1 pattern line PAL1-1 and the 1-2 pattern line PAL1-2 have a width of the first direction 1D and a length of the second direction 2D. In addition, the 1-1 pattern line PAL1-1 and the 1-2 pattern line PAL1-2 are spaced apart from each other. Specifically, the 1-1 pattern line PAL1-1 and the 1-2 pattern line PAL1-2 are spaced apart from each other in the first direction 1D.

Accordingly, the first unit patterns UP1 adjacent in the first direction 1D are formed in the same shape. For example, any one of the first unit patterns UP1 adjacent in the first direction 1D may be the 1-1 pattern line PAL1-1. In addition, another first unit pattern may be the 1-2 pattern line PAL1-2.

In addition, the first unit patterns UP1 adjacent in the second direction 2D are formed in the same shape. For example, all of the first unit patterns UP1 adjacent in the second direction 2D may be the 1-1 pattern line PAL1-1. Or, all of them may be the 1-2 pattern line PAL1-2.

In addition, the first unit patterns UP1 adjacent in the diagonal directions of the first direction 1D and the second direction 2D are formed in the same shape. For example, any one first unit pattern among the first unit patterns UP1 adjacent in the diagonal direction may be the 1-1 pattern line PAL1-1. In addition, another first unit pattern may be the 1-2 pattern line PAL1-2.

That is, the first pattern PA1 is a collection of a plurality of first unit patterns UP1.

The first unit pattern UP1 is formed in a symmetrical shape. For example, the first unit pattern UP1 may be symmetrical in the first direction 1D passing through the center of the first unit pattern UP1. That is, the first unit pattern UP1 may be symmetrical with respect to the first direction 1D. In addition, the first unit pattern UP1 is not symmetrical in the second direction 2D perpendicular to the first direction 1D. That is, the first unit pattern UP1 is not symmetrical with respect to the second direction 2D. Therefore, the first unit pattern UP1 satisfies either left-right symmetry or up-down symmetry. In addition, the first unit pattern UP1 does not satisfy left-right symmetry and up-down symmetry at the same time.

The first unit pattern UP1 is formed to have a different width at each location. Specifically, the first unit pattern UP1 may have the widest width in the central area CA1 including the center C1 of the first unit pattern UP1.

The first unit pattern UP1 includes a body unit BA1 and a wing unit WA1 extending from the body unit BA1. The wing unit WA1 is shaped symmetrical with respect to the body unit BA1. In addition, the width of the body unit BA1 is large in the first direction 1D, and the width of the wing unit WA1 is smaller than the width of the body unit BA1.

The first pattern PA1 may have a thickness of a range set in advance. Specifically, the first pattern PA1 is related to the wavelength size of light reacting with the first pattern PA1.

The thickness of the first pattern PA1 may be smaller than the wavelength of light reacting with the first pattern PA1. Specifically, the thickness of the first pattern PA1 may be smaller than the first wavelength and the third wavelength reacting with the first pattern PA1. The thickness of the first pattern PA1 satisfies equation 1 shown below.

$$First wavelength * 0.45 < Thickness of first pattern \leq First wavelength * 0.75 , and \qquad [ Equation 1 ]$$

$$Third wavelength * 0.35 < Thickness of first pattern \leq Third wavelength * 0.65 ,$$

(Here, the first wavelength is 450 to 490 nm, and the third wavelength is 490 to 570 nm)

When the thickness of the first pattern PA1 satisfies equation 1, the interaction between the light entering at an angle set in advance and the first pattern PA1 increases. Accordingly, the diffraction efficiency of the first light and the third light is improved.

However, when the thickness of the first pattern PA1 is smaller than or equal to 0.45 of the first wavelength, the interaction between the first light entering at an angle set in advance and the first pattern PA1 decreases. Accordingly, the diffraction efficiency of the first light and the third light is lowered. In addition, when the thickness of the first pattern PA1 exceeds 0.75 of the first wavelength, the change in the diffraction efficiency of the first light entering at a different angle increases. Accordingly, the diffraction efficiency becomes non-uniform.

In addition, when the thickness of the first pattern PA1 is smaller than or equal to 0.35 of the third wavelength, the interaction between the third light entering at an angle set in advance and the first pattern PA1 decreases. Accordingly, the diffraction efficiency is lowered. In addition, when the thickness of the first pattern PA1 exceeds 0.65 of the third wavelength, the change in the diffraction efficiency of the third light entering at a different angle increases. Accordingly, the diffraction efficiency becomes non-uniform.

The first unit pattern UP1 has a size of a range set in advance. The first unit pattern UP1 has a length of the first direction L1-1 and a length of the second direction L1-2. The length of the first direction L1-1 and the length of the second direction L1-2 have a range set in advance.

The length of the first direction L1-1 and the length of the second direction L1-2 may be the same. That is, the first unit pattern UP1 may be formed in a square shape.

Alternatively, the length of the first direction L1-1 and the length of the second direction L1-2 may be different. For example, the length of the first direction L1-1 may be longer than the length of the second direction L1-2. Alternatively, the length of the first direction L1-1 may be shorter than the length of the second direction L1-2. That is, the first unit pattern UP1 may be formed in a rectangular shape.

The length of the first direction L1-1 and the length of the second direction L1-2 are related to the wavelength sizes of the first light and the third light reacting with the first pattern PA1.

At least one among the length of the first direction L1-1 and the length of the second direction L1-2 may be shorter than the wavelength of the first light and the wavelength of the third light reacting with the first pattern PA1. Specifically, the length of the first direction L1-1 and the length of the second direction L1-2 satisfy equation 2 shown below.

$$First wavelength * 0.65 < Length of first direction L 1 - 1 \leq First wavelength * 0.9 , or \qquad [ Equation 2 ]$$

$$First wavelength * 0.65 < Length of second direction L 1 - 2 \leq First wavelength * 0.9 , or$$

$$First wavelength * 0.65 < Length of first and second directions L 1 - 1 and L 1 - 2 \leq First wavelength * 0.9 ,$$

$$Third wavelength * 0.6 < Length of first direction L 1 - 1 \leq Third wavelength * 0.8 , or$$

$$Third wavelength * 0.6 < Length of second direction L 1 - 2 \leq Third wavelength * 0.8 , or$$

$$Third wavelength * 0.6 < Length of first and second directions L 1 - 1 and L 1 - 2 \leq Third wavelength * 0.8 .$$

(Here, the first wavelength is 450 to 490 nm, and the third wavelength is 490 to 570 nm)

When equation 2 is satisfied, the interaction between the first light and the third light entering at an angle set in advance and the first pattern PA1 increases. Accordingly, the diffraction efficiency is improved.

However, when equation 2 is not satisfied, the interaction between the first light and the third light entering at an angle set in advance and the first pattern PA1 decreases. Accordingly, the diffraction efficiency is lowered.

Alternatively, the length of the first direction L1-1 and the length of the second direction L1-2 are related to the thickness of the first pattern PA1.

At least one among the length of the first direction L1-1 and the length of the second direction L1-2 may be greater than the thickness of the first pattern PA1. Specifically, the length of the first direction L1-1 and the length of the second direction L1-2 satisfy equation 3 shown below.

$$Length of first direction L 1 - 1 * 0.55 < Thickness of first pattern \leq Length of first direction L 1 - 1 * 0.8 , or \qquad [ Equation 3 ]$$

$$Length of second direction L 1 - 2 * 0.55 < Thickness of first pattern \leq Length of second direction L 1 - 2 * 0.8 , or$$

$$Length of first and second directions L 1 - 1 and L 1 - 2 * 0.55 < Thickness of first pattern \leq Length of first and second directions L 1 - 1 and L 1 - 2 * 0.8 .$$

When equation 3 is satisfied, the interaction between the first light and the third light entering at an angle set in advance and the first pattern PA1 increases. Accordingly, the diffraction efficiency is improved.

However, when equation 3 is not satisfied, the interaction between the first light and the third light entering at an angle set in advance and the first pattern PA1 decreases. Accordingly, the diffraction efficiency is lowered.

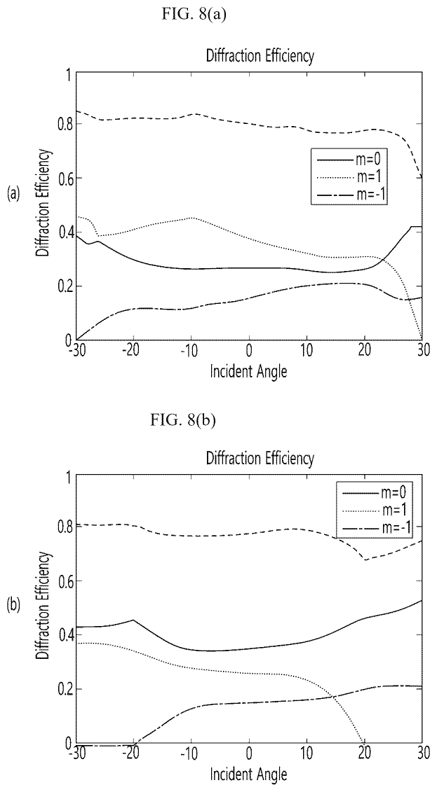

In each of FIGS. 8 to 10, (a) is a graph showing the diffraction efficiency of the first light (blue light) having a wavelength of 450 to 490 nm. (b) is a graph showing the diffraction efficiency of the third light (green light) having a wavelength of 490 to 570 nm.

In the graphs of FIGS. 8 to 10, m=0 means light that is transmitted (refracted) without diffraction. m=1 means diffracted light. m=−1 means light that generates various side effects according to the environment although diffraction is not aimed. In addition, lines other than m=−1, m=0, and m=1 mean the sum of diffraction efficiencies of the −1st, 0th, and 1st orders, and mean that there are efficiencies of higher-order terms other than the −1st, 0th, and 1st orders.

Referring to FIGS. 8 to 10, the curve of m=1 has uniform and high diffraction efficiency in a range of −23° to 23°.

That is, the first light guide including the first pattern according to an embodiment has uniform and high diffraction efficiency within a wide range of incident angle.

Hereinafter, the second light guide will be described with reference to FIGS. 11 to 16.

Referring to FIGS. 11 to 13, the second light guide 1100 includes a second substrate 120 and a second pattern PA2.

The second pattern PA2 diffracts light having a wavelength of a range set in advance. Specifically, the second pattern PA2 selectively diffracts at least one light among the second light and the third light. That is, the second pattern PA2 selectively diffracts red light. Alternatively, the second pattern PA2 selectively diffracts green light. Alternatively, the second pattern PA2 selectively diffracts red light and green light.

Hereinafter, for convenience of explanation, a case where the second pattern PA2 selectively diffracts the second light and the third light is described.

The second substrate 120 includes a first transmission region T1 and a second transmission region T2 by the second pattern PA2. The first transmission region T1 is a region where the second pattern PA2 is not arranged. The second transmission region T2 is a region where the second pattern PA2 is arranged. Light passing through the second light guide 1200 is diffracted by the first transmission region T1 and the second transmission region T2. Specifically, a phase difference occurs between the light passing through the first transmission region T1 and the light passing through the second transmission region T2. The sum of the phase difference may appear as a diffraction phenomenon.

The second pattern PA2 may include a plurality of unit patterns. For example, the second pattern PA2 may include a plurality of second unit patterns UP2. When the second substrate 120 is divided into a plurality of unit areas, a structure in which a structure body of the same shape is repeated in the plurality of unit areas is defined as the second unit pattern UP2.

The second unit pattern UP2 is arranged on the surface of the second light guide where light enters. In addition, the light entering the second light guide is guided by the second unit pattern UP1.

The second unit patterns UP2 are connected to each other. Accordingly, a second pattern line PAL2 is formed.

The second pattern PA2 includes a plurality of second pattern lines PAL2. In addition, the second pattern lines PAL2 are spaced apart from each other. Specifically, the second pattern lines PAL2 are not connected to each other.

For example, the second pattern PA2 may include a 2-1 pattern line PAL2-1 and a 2-2 pattern line PAL2-2. The 2-1 pattern line PAL2-1 and the 2-2 pattern line PAL2-2 extend in the second direction 2D. That is, the 2-1 pattern line PAL2-1 and the 2-2 pattern line PAL2-2 have a width of the first direction 1D and a length of the second direction 2D. In addition, the 2-1 pattern line PAL2-1 and the 2-2 pattern line PAL2-2 are spaced apart from each other. Specifically, the 2-1 pattern line PAL2-1 and the 2-2 pattern line PAL2-2 are spaced apart from each other in the first direction 1D.

Accordingly, the second unit patterns UP2 adjacent in the first direction 1D are formed in the same shape. For example, any one of the second unit patterns UP2 adjacent in the first direction 1D may be the 2-1 pattern line PAL2-1. In addition, another second unit pattern may be the 2-2 pattern line PAL2-2.

In addition, the second unit patterns UP2 adjacent in the second direction 2D are formed in the same shape. For example, all of the second unit patterns UP2 adjacent in the second direction 2D may be the 2-1 pattern line PAL2-1. Or, all of them may be the 2-2 pattern line PAL2-2.

In addition, the second unit patterns UP2 adjacent in the diagonal directions of the first direction 1D and the second direction 2D are formed in the same shape. For example, any one second unit pattern among the second unit patterns UP2 adjacent in the diagonal direction may be the 2-1 pattern line PAL2-1. In addition, another second unit pattern may be the 2-2 pattern line PAL2-2.

That is, the second pattern PA2 is a collection of a plurality of second unit patterns UP2.

The first pattern line PAL1 and the second pattern line PAL2 may or may not overlap.

For example, any one first pattern line may be positioned between two adjacent second pattern lines PAL2. That is, the first pattern line PAL1 and the second pattern line PAL2 may not overlap.

Alternatively, at least one first pattern line may overlap at least one second pattern line. That is, the first pattern line PAL1 and the second pattern line PAL2 may overlap.

In addition, the first pattern line PAL1 and the second pattern line PAL2 may be parallel to each other. Specifically, at least one first pattern line may be parallel to at least one second pattern line.

The second unit pattern UP2 is formed in a symmetrical shape. For example, the second unit pattern UP2 may be symmetrical in the first direction 1D passing through the center of the second unit patterns UP2. That is, the second unit pattern UP2 may be symmetrical with respect to the first direction 1D. In addition, the second unit pattern UP2 is not symmetrical in the second direction 2D perpendicular to the first direction 1D. That is, the second unit pattern UP2 is not symmetrical with respect to the second direction 2D. Therefore, the second unit pattern UP2 satisfies either left-right symmetry or up-down symmetry. In addition, the second unit pattern UP2 does not satisfy left-right symmetry and up-down symmetry at the same time.

The second unit pattern UP2 is formed to have a different width at each location. Specifically, the second unit pattern UP2 may have the widest width in the central area CA2 including the center C2 of the second unit pattern UP2.

The second unit pattern UP2 includes a body unit BA2 and a wing unit WA2 extending from the body unit BA2. The wing unit WA2 is shaped symmetrical with respect to the body unit BA2. In addition, the width of the body unit BA2 is large in the first direction 1D, and the width of the wing unit WA2 is smaller than the width of the body unit BA2.

The second pattern P2 may have a thickness of a range set in advance. Specifically, the second pattern P2 is related to the wavelength size of light reacting with the second pattern P2.

The thickness of the second pattern P2 may be smaller than the wavelength of light reacting with the second pattern P2. Specifically, the thickness of the second pattern P2 may be smaller than the second wavelength and the third wavelength reacting with the second pattern P2. The thickness of the second pattern P2 satisfies equation 4 shown below.

$$Second wavelength * 0.4 < Thickness of second pattern \leq First wavelength * 0.6 , and \qquad [ Equation 4 ]$$

$$Third wavelength * 0.45 < Thickness of second pattern \leq Third wavelength * 0.65 .$$

(Here, the second wavelength is 620 to 780 nm, and the third wavelength is 490 nm to 570 nm)

When equation 4 is satisfied, the interaction between the light entering at an angle set in advance and the second pattern P2 increases. Accordingly, the diffraction efficiency of the second light and the third light is improved.

However, when the thickness of the second pattern P2 is smaller than or equal to 0.4 of the second wavelength, the interaction between the second light entering at an angle set in advance and the second pattern P2 decreases. Accordingly, the diffraction efficiency is lowered. In addition, when the thickness of the second pattern P2 exceeds 0.6 of the second wavelength, the change in the diffraction efficiency of the second light entering at a different angle increases. Accordingly, the diffraction efficiency becomes non-uniform.

In addition, when the thickness of the second pattern P2 is smaller than or equal to 0.45 of the third wavelength, the interaction between the third light entering at an angle set in advance and the second pattern P2 decreases. Accordingly, the diffraction efficiency is lowered. In addition, when the thickness of the second pattern P2 exceeds 0.65 of the third wavelength, the change in the diffraction efficiency of the third light entering at a different angle increases. Accordingly, the diffraction efficiency becomes non-uniform.

The second unit pattern UP2 has a size of a range set in advance. The second unit pattern UP2 has a length of the first direction L2-1 and a length of the second direction L2-2. The length of the first direction L2-1 and the length of the second direction L2-2 have a range set in advance.

The length of the first direction L2-1 and the length of the second direction L2-2 may be the same. That is, the second unit pattern UP2 may be formed in a square shape.

Alternatively, the length of the first direction L2-1 and the length of the second direction L2-2 may be different. For example, the length of the first direction L2-1 may be longer than the length of the second direction L2-2. Alternatively, the length of the first direction L2-1 may be shorter than the length of the second direction L2-2. That is, the second unit pattern UP2 may be formed in a rectangular shape.

The length of the first direction L2-1 and the length of the second direction L2-2 are related to the wavelength sizes of the second light and the third light reacting with the second pattern PA2.

At least one among the length of the first direction L2-1 and the length of the second direction L2-2 may be shorter than the wavelength of the second light and the wavelength of the third light reacting with the second pattern PA2. Specifically, the length of the first direction L2-1 and the length of the second direction L2-2 satisfy equation 5 shown below.

$$Second wavelength * 0.65 < Length of first direction L 2 - 1 \leq Second wavelength * 0.85 , or \qquad [ Equation 5 ]$$

$$Second wavelength * 0.65 < Length of second direction L 2 - 2 \leq Second wavelength * 0.85 , or$$

$$Second wavelength * 0.65 < Length of first and second directions L 2 - 1 and L 2 - 2 \leq Second wavelength * 0.85 ,$$

$$Third wavelength * 0.8 \leq Length of first direction L 2 - 1 < Third wavelength * 0.9 , or$$

$$Third wavelength * 0.8 \leq Length of second direction L 2 - 2 < Third wavelength * 0.9 , or$$

$$Third wavelength * 0.8 \leq Length of first and second directions L 2 - 1 and L 2 - 2 < Third wavelength * 0.9 .$$

(Here, the second wavelength is 620 to 780 nm, and the third wavelength is 490 to 550 nm)

When equation 5 is satisfied, the interaction between the second light and the third light entering at an angle set in advance and the second structure body increases. Accordingly, the diffraction efficiency is improved.

However, when equation 5 is not satisfied, the interaction between the second light and the third light entering at an angle set in advance and the second structure body decreases. Accordingly, the diffraction efficiency is lowered.

Alternatively, the length of the first direction L2-1 and the length of the second direction L2-2 are related to the thickness of the second pattern PA2.

At least one among the length of the first direction L2-1 and the length of the second direction L2-2 may be greater than the thickness of the second pattern PA2. Specifically, the length of the first direction L2-1 and the length of the second direction L2-2 satisfy equation 6 shown below.

$$Length of first direction L 2 - 1 * 0.6 < Thickness of second pattern \leq Length of first direction L 2 - 1 * 0.8 , or \qquad [ Equation 6 ]$$

$$Length of second direction L 2 - 2 * 0.6 < Thickness of second pattern \leq Length of second direction L 2 - 2 * 0.8 , or$$

$$Length of first and second directions L 2 - 1 and L 2 - 2 * 0.6 < Thickness of second pattern \leq Length of first and second directions L 2 - 1 and L 2 - 2 * 0.8$$

When equation 6 is satisfied, the interaction between the second light and the third light entering at an angle set in advance and the second structure body increases. Accordingly, the diffraction efficiency is improved.

However, when equation 6 is not satisfied, the interaction between the second light and the third light entering at an angle set in advance and the second structure body decreases. Accordingly, the diffraction efficiency is lowered.

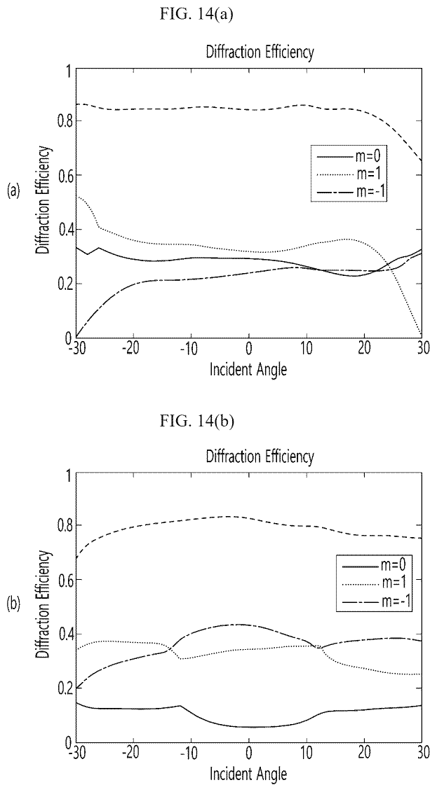

In each of FIGS. 14 to 16, (a) is a graph showing the diffraction efficiency of second light (red light) having a wavelength of 620 to 780 nm. (b) is a graph showing the diffraction efficiency of third light (green light) having a wavelength of 490 to 570 nm.

In the graphs of FIGS. 14 to 16, m=0 means light that is transmitted (refracted) without diffraction. m=1 means diffracted light. m=−1 means light that generates various side effects according to the environment although diffraction is not aimed. In addition, lines other than m=−1, m=0, and m=1 mean the sum of diffraction efficiencies of the −1st, 0th, and 1st orders, and mean that there are efficiencies of higher-order terms other than the −1st, 0th, and 1st orders.

Referring to FIGS. 14 to 16, the curve of m=1 has uniform and high diffraction efficiency in a range of −23° to 23°.

That is, the second light guide including the second pattern according to an embodiment has uniform and high diffraction efficiency within a wide range of incident angle.

Hereinafter, an example of a display device including a light guide module according to an embodiment will be described with reference to FIG. 17.

Referring to FIG. 17, the optical device may be applied to a wearable display device. Specifically, the optical device may be applied to a wearable display device worn on the head or ear of a human body.

For example, the display device 3000 may be an augmented reality device.

The display device 3000 includes a wearing unit 3100 and a display unit 3200. The display unit 3200 may be AR glasses. Alternatively, the display unit 3200 may be the light guide module described above.

The wearing unit 3100 extends in one direction. The wearing unit 3100 may be worn on the user's body. For example, the wearing unit 3100 is worn on the head or ear of a user. Accordingly, the display device 3000 is fixed to the user's body.

In addition, the projector 15 is connected to the wearing unit 3100 or the display unit 3200. For example, the projector 15 is connected to the wearing unit 3100. In addition, the projector 15 is arranged to be adjacent to the display unit 3200.

Alternatively, the projector 15 may be arranged on the top of the display unit 3200.

The projector 15 transfers light toward the display unit 3200. Specifically, the projector 15 transfers light, in which image information is output by an optical signal generation unit, to the display unit 3200.

According thereto, the user receives the image information through the display unit 3200. Accordingly, the user recognizes augmented reality through the optical device.

The features, structures, effects, and the like described above in the embodiments are included in at least one embodiment of the present invention, and are not necessarily limited to only one embodiment. Furthermore, the features, structures, effects, and the like exemplified in each embodiment may also be combined or modified and implemented in other embodiments by those skilled in the art. Therefore, the contents related to such combinations and modifications should be interpreted as being included in the scope of the present invention.

In addition, although it has been described above focusing on the embodiments, these are only examples and do not limit the present invention. Those skilled in the art will appreciate that various modifications and applications not exemplified above are possible without departing from the essential characteristics of the present embodiment. For example, each component specifically shown in the embodiments can be modified to be embodied. In addition, differences related to such modifications and applications should be interpreted as being included in the scope of the present invention defined in the appended claims.

1. A light guide module comprising a first light guide and a second light guide, wherein
the first light guide includes a first pattern region that reacts with first light of a first wavelength and third light of a third wavelength and has a first pattern arranged therein,
the second light guide includes a second pattern region that reacts with second light of a second wavelength and the third light of the third wavelength and has a second pattern arranged therein,
the first pattern region includes a plurality of first unit patterns,
the second pattern region includes a plurality of second unit patterns different from the first unit patterns, and
the first unit pattern is widest in a central region including a center and is symmetrical with respect to a first direction passing through the center.

2. The light guide module according to claim 1, wherein the first pattern region guides blue light and a part of green light, the second pattern region guides red light and another part of the green light, the first pattern region transmits another part of the green light and the red light and diffuses the blue light and a part of the green light, and the second pattern region diffuses the red light and another part of the green light.

3. The light guide module according to claim 1, wherein the first unit patterns are connected to each other to form a first pattern line, and the first pattern region includes a plurality of first pattern lines.

4. The light guide module according to claim 3, wherein the first pattern lines are not connected to each other.

5. The light guide module according to claim 1, wherein the first unit pattern is not symmetrical in a second direction perpendicular to the first direction.

6. The light guide module according to claim 1, wherein the first unit pattern does not satisfy left-right symmetry and up-down symmetry at the same time.

7. The light guide module according to claim 1, wherein the first pattern region and the second pattern region are arranged to overlap in a direction perpendicular to a surface of the first light guide.

8. The light guide module according to claim 1, wherein the first unit pattern includes a wing unit extended from a body unit, wherein the wing unit is shaped symmetrical with respect to the body unit.

9. The light guide module according to claim 8, wherein in the first unit pattern, pattern a width of the wing unit is smaller than a width of the body unit in the first direction.

10. The light guide module according to claim 1, wherein the first unit pattern is arranged on a surface where light is incident and enters, which is one surface of the first light guide, and the first unit pattern guides the incident light.

11. The light guide module according to claim 1, wherein the light guide module includes a first substrate on which the first pattern is arranged.

12. The light guide module according to claim 11, wherein the first substrate includes a first transmission region where the first pattern is not arranged and a second transmission region where the first pattern is arranged.

13. The light guide module according to claim 1, wherein a thickness of the first pattern is smaller than the first wavelength and the third wavelength.

14. The light guide module according to claim 13, wherein the thickness of the first pattern satisfies equation 1,
$$First wavelength * 0.45 < Thickness of first pattern \leq First wavelength * 0.75 , and \qquad [ Equation l ]$$
$$Third wavelength * 0.35 < Thickness of first pattern \leq Third wavelength * 0.65$$
$$( Here , the first wavelength is 450 to 490 nm , and the third wavelength$$
$$is 490 to 570 nm ) .$$

15. The light guide module according to claim 5, wherein at least one among a length of the first direction of the first unit pattern and a length of the second direction of the first unit pattern is shorter than the first wavelength and the third wavelength.

16. The light guide module according to claim 15, wherein the length of the first direction of the first unit pattern and the length of the second direction of the first unit pattern satisfy equation 2,
$$First wavelength * 0.65 < Length of first direction L 1 - 1 \leq First wavelength * 0.9 , or \qquad [ Equation 2 ]$$
$$First wavelength * 0.65 < Length of second direction L 1 - 2 \leq First wavelength * 0.9 , or$$
$$First wavelength * 0.65 < Length of first and second directions L 1 - 1 and L 1 - 2 \leq First wavelength * 0.9 ,$$
$$Third wavelength * 0.6 < Length of first direction L 1 - 1 \leq Third wavelength * 0.8 , or$$
$$Third wavelength * 0.6 < Length of second direction L 1 - 2 \leq Third wavelength * 0.8 , or$$
$$Third wavelength * 0.6 < Length of first and second directions L 1 - 1 and L 1 - 2 \leq Third wavelength * 0.8$$
(Here, the first wavelength is 450 to 490 nm, and the third wavelength is 490 to 570 nm).

17. The light guide module according to claim 5, wherein at least one among a length of the first direction of the first unit pattern and a length of the second direction of the first unit pattern is greater than a thickness of the first pattern.

18. The light guide module according to claim 5, wherein the length of the first direction of the first unit pattern, the length of the second direction of the first unit pattern, and the thickness of the first pattern satisfy equation 3,
$$Length of first direction * 0.55 < Thickness of first pattern \leq Length of first direction * 0.8 , or \qquad [ Equation 3 ]$$
$$Length of second direction * 0.55 < Thickness of first pattern \leq Length of second direction * 0.8 , or$$
$$Length of first and second directions * 0.55 < Thickness of first pattern \leq Length of first and second directions * 0.8 .$$

19. The light guide module according to claim 1, wherein the light guide module includes a second substrate on which the second pattern is arranged, and the second substrate includes a first transmission region where the first pattern is not arranged and a second transmission region where the first pattern is arranged.

20. The light guide module according to claim 19, wherein a thickness of the second pattern is smaller than the second wavelength and the third wavelength.
